(19) United States
(12) Patent Application Publication
(10) Pub. No.: US 2025/0237911 A1
(43) Pub. Date: Jul. 24, 2025

(54) DISPLAY DEVICE

(71) Applicant: Japan Display Inc., Tokyo (JP)

(72) Inventor: Yuji MAEDE, Tokyo (JP)

(73) Assignee: Japan Display Inc., Tokyo (JP)

(21) Appl. No.: 19/026,891

(22) Filed: Jan. 17, 2025

(30) Foreign Application Priority Data
Jan. 22, 2024 (JP) 2024-007275

(51) Int. Cl. G02F 1/1343; G02F 1/1334; G02F 1/1362

(52) U.S. Cl. CPC G02F 1/134318; G02F 1/1334; G02F 1/136286

(57) ABSTRACT

According to one embodiment, a display device comprises a display panel, a plurality of light emitting elements, a transparent substrate, and a plurality of structures. The display panel comprises a liquid crystal layer containing polymer dispersed liquid crystal, a first pixel electrode, and a second pixel electrode. The transparent substrate faces the plurality of light emitting elements. A plurality of structures are in contact with the display panel and the transparent substrate. The plurality of structures include a plurality of first structures overlapping the first pixel electrode and a second structure having a plurality of apertures overlapping the second pixel electrode.

### CROSS-REFERENCE TO RELATED APPLICATIONS

This application is based upon and claims the benefit of priority from Japanese Patent Application No. 2024-007275, filed Jan. 22, 2024, the entire contents of which are incorporated herein by reference.

### FIELD

Embodiments described herein relate generally to a display device.

### BACKGROUND

Recently, various types of illumination devices using polymer dispersed liquid crystal (hereinafter referred to as “PDLC”) capable of changing a diffusing state and a transmitting state have been proposed. As an example, a display device using PDLC comprises: a display panel; a transparent substrate bonded to the display panel; a light source provided on an end side of the transparent substrate; and a low-refractive layer located between the display panel and the transparent substrate and having a refractive index smaller than that of the transparent substrate. The low-refractive layer has a plurality of apertures. For example, among the apertures, the farther an aperture from the light sources, the smaller its size.

For example, siloxane-based resin, which is used as a material of the low-refractive layer, easily gasifies and may cause various adverse effect during the production process. The trend toward regulating fluorine compounds, which are used as another material of the low-refractive layer, is globally on the rise.

### BRIEF DESCRIPTION OF THE DRAWINGS

FIG. 1 is a view showing a configuration example of a display device DSP of the first embodiment.

FIG. 2 is a cross-sectional view showing the configuration example of the display panel PNL shown in FIG. 1.

FIG. 3 is a schematic cross-sectional view showing the display device DSP along line A-A′ shown in FIG. 1.

FIG. 4 is a plan view showing an example of first structures 41.

FIG. 5 is a plan view showing an example of second structures 42 and apertures AP.

FIG. 6 is a plan view showing a configuration example of structures 40 and an adhesive AD.

FIG. 7 is a plan view showing another configuration example of the structures 40 and the adhesive AD.

FIG. 8 is a plan view showing an example of a relationship among the structures 40 and pixel electrodes PE.

FIG. 9 is a plan view showing another configuration example of the relationship among the structures 40 and the pixel electrodes PE.

FIG. 10 is a view showing a schematic configuration example of a display device DSP of the second embodiment.

FIG. 11 is a schematic cross-sectional view showing the display device DSP along line B-B′ shown in FIG. 10.

### DETAILED DESCRIPTION

In general, according to one embodiment, a display device comprises a display panel, a plurality of light emitting elements, a third transparent substrate, and a plurality of structures. The display panel comprises: a first transparent substrate, a second transparent substrate facing the first transparent substrate; a liquid crystal layer located between the first transparent substrate and the second transparent substrate and containing polymer dispersed liquid crystal; a first pixel electrode and a second pixel electrode that are located between the first transparent substrate and the liquid crystal layer; and a common electrode located between the second transparent substrate and the liquid crystal layer and facing the first pixel electrode and the second pixel electrode. The plurality of light emitting elements are arranged in a first direction. The third transparent substrate has a side surface, which faces the plurality of light emitting elements, and faces the second transparent substrate. The second transparent substrate is located between the first transparent substrate and the third transparent substrate. The plurality of structures are in contact with the second transparent substrate and the third transparent substrate and guide light, which is emitted from the plurality of light emitting elements, from the third transparent substrate to the liquid crystal layer. The first pixel electrode is located between the plurality of light emitting elements and the second pixel electrode in plan view. The plurality of structures include: a plurality of first structures overlapping the first pixel electrode; a second structure having a plurality of apertures overlapping the second pixel electrode. The plurality of first structures and the plurality of apertures are both arranged at a first pitch in the first direction and are arranged in a second pitch in a second direction orthogonal to the first direction, the second pitch being equivalent to the first pitch. Some of the plurality of first structures overlap the first pixel electrode. A sum of areas of the some of the first structures is smaller than an area in which the second structure overlaps the second pixel electrode.

In general, according to another embodiment, a display device comprises a display panel, a plurality of light emitting elements, a third transparent substrate, and a plurality of resin layers. The display panel comprises: a first transparent substrate, a second transparent substrate facing the first transparent substrate; a liquid crystal layer located between the first transparent substrate and the second transparent substrate and containing polymer dispersed liquid crystal; a first pixel electrode and a second pixel electrode that are located between the first transparent substrate and the liquid crystal layer; and a common electrode located between the second transparent substrate and the liquid crystal layer and facing the first pixel electrode and the second pixel electrode. The plurality of light emitting elements are arranged in a first direction. The third transparent substrate has a side surface facing the plurality of light emitting elements. The second transparent substrate is located between the first transparent substrate and the third transparent substrate. The plurality of resin layers are located between a main surface of the second transparent substrate and a main surface of the third transparent substrate. The first pixel electrode is located between the plurality of light emitting elements and the second pixel electrode in plan view. The plurality of resin layers comprise: a plurality of first resin layers overlapping the first pixel electrode; and a second resin layer having a plurality of apertures overlapping the second pixel electrode. Some of the first plurality of resin layers overlap the first pixel electrode. The second resin layer fully overlaps the second pixel electrode.

Embodiments can provide a display device capable of suppressing the degradation in display quality without low refractive index materials.

Embodiments will be described with reference to the accompanying drawings.

The disclosure is merely an example, and proper changes in keeping with the spirit of the invention, which are easily conceivable by a person of ordinary skill in the art, come within the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. In addition, in the specification and drawings, structural elements which function in the same or a similar manner to those described in connection with preceding drawings are denoted by like reference numbers, detailed description thereof being omitted unless necessary.

In the figures, an X-axis, a Y-axis, and a Z-axis orthogonal to one other are described to facilitate understanding as needed. A direction along the X-axis is referred to as a first direction X, a direction along the Y-axis is referred to as a second direction Y, and a direction along the Z-axis is referred to as a third direction Z. A plan view is defined as appearance when various types of elements are viewed parallel to the third direction Z. The first direction X and the second direction Y correspond to the directions parallel to the main surface of a substrate which constitutes the display device DSP, and the third direction Z corresponds to the thickness direction of the display device DSP.

As an example of display devices, the present embodiment discloses a liquid crystal display device (transparent display device) to which polymer dispersed liquid crystals are applied and which has high light translucency. The configuration disclosed in the present embodiment, especially the configuration related to various elements provided in a mounting area and its vicinity, can be also applied to other types of display devices.

### First Embodiment

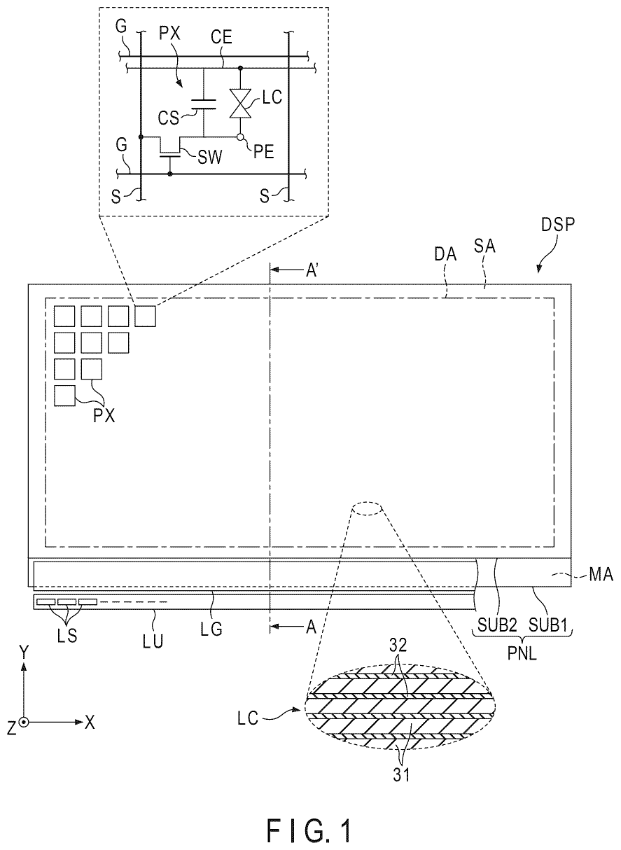

FIG. 1 is a view showing a configuration example of a display device DSP of the first embodiment. The display device DSP comprises a display panel PNL, a light source unit LU, and a light guide LG. In FIG. 1, parts of the light source unit LU and the light guide LG are represented by the break line and the illustration of these portions is partially omitted.

The display panel PNL comprises a first substrate SUB1 and a second substrate SUB2 that are stacked in the third direction Z. In FIG. 1, each of the first substrate SUB1 and the second substrate SUB2 has a rectangular shape having long sides parallel to the first direction X in plan view. The shapes of the first substrate SUB1 and the second substrate SUB2 are not limited to this example. For example, the first substrate SUB1 and the second substrate SUB2 may have shapes such as a rectangular shape having long sides parallel to the second direction Y, a circular shape, and an elliptic shape.

The width of the first substrate SUB1 in the second direction Y is greater than the width of the second substrate SUB2 in the second direction Y. Thus, the first substrate SUB1 has a mounting area MA, which does not overlap the second substrate SUB2. In the mounting area MA, integrated circuits and flexible printed circuits (not shown) are mounted.

The display panel PNL includes a display area DA which displays an image and a surrounding area SA having a frame shape surrounding the display area DA. Both the display area DA and the surrounding area SA are formed on portions on which the first substrate SUB1 overlaps the second substrate SUB2. The display area DA comprises a plurality of pixels PX arranged in a matrix in the first direction X and the second direction Y.

The display panel PNL further comprises a liquid crystal layer LC sealed between the first substrate SUB1 and the second substrate SUB2. As shown in a lower side of FIG. 1 in the enlarged and schematic manner, the liquid crystal layer LC is composed of polymer dispersed liquid crystal containing polymers 31 and liquid crystal molecules 32. For example, the polymers 31 are liquid crystal polymers. The polymers 31 are formed in stripe shapes extending along the first direction X and are arranged in the second direction Y. The liquid crystal molecules 32 are dispersed in gaps between the polymers 31 and are arranged such that the longer axes of the liquid crystal molecules 32 are along the first direction X.

Each of the polymers 31 and the liquid crystal molecules 32 has optical anisotropy or refractive anisotropy. The responsive property of the polymers 31 to the electric field is lower than the responsive property of the liquid crystal molecules 32 to the electric field. For example, the alignment direction of the polymers 31 hardly varies irrespective of the presence or absence of the electric field. In contrast, the alignment direction of the liquid crystal molecules 32 varies in response to voltages applied to the liquid crystal layer LC.

When no voltage is applied to the liquid crystal layer LC, the optical axes of the polymers 31 are parallel to those of the liquid crystal molecules 32, and the light made incident on the liquid crystal layer LC is not substantially scattered inside the liquid crystal layer LC and passes through the liquid crystal layer LC (transparent state).

When a voltage is applied to the liquid crystal layer LC, the optical axes of the polymers 31 intersect those of the liquid crystal molecules 32, and the light made incident on the liquid crystal layer LC is scattered inside the liquid crystal layer LC (scattered state).

As shown in the upper side of FIG. 1 in the enlarged manner, a plurality of scanning lines G and a plurality of signal lines S are provided in the display area DA. The plurality of scanning lines G extend in the first direction X and are arranged in the second direction Y. The plurality of signal lines S extend in the second direction Y and are arranged in the first direction X. The plurality of signal lines S intersect the plurality of scanning lines G.

Each pixel PX comprises a switching element SW, a pixel electrode PE, a common electrode CE, and a capacity CS. The switching element SW is constituted by, for example, a thin-film transistor (TFT) and is electrically connected to the scanning line G and the signal line S. The pixel electrode PE is electrically connected to the switching element SW.

The liquid crystal layer LC (particularly, the liquid crystal molecules 32) is driven by an electric field produced between the pixel electrode PE and the common electrode CE. A capacitor CS is formed, for example, between the common electrode CE and an electrode having the same electric potential as the common electrode CE and between the pixel electrode PE and an electrode having the same potential as the pixel electrode PE.

The light source unit LU and the light guide LG are provided along the mounting area MA. The light source unit LU comprises a plurality of light emitting elements LS arranged in the first direction X. Each of the light emitting elements LS emits light toward the light guide LG. For example, a lens such as a prism lens can be used as the light guide LG.

For example, the plurality of light emitting elements LS include a light emitting element emitting red light, a light emitting element emitting green light, and a light emitting element emitting blue light. These light emitting elements may be arranged in the first direction X or may be stacked in the third direction Z. Light emitting diodes (LEDs) can be used as the light emitting elements LS.

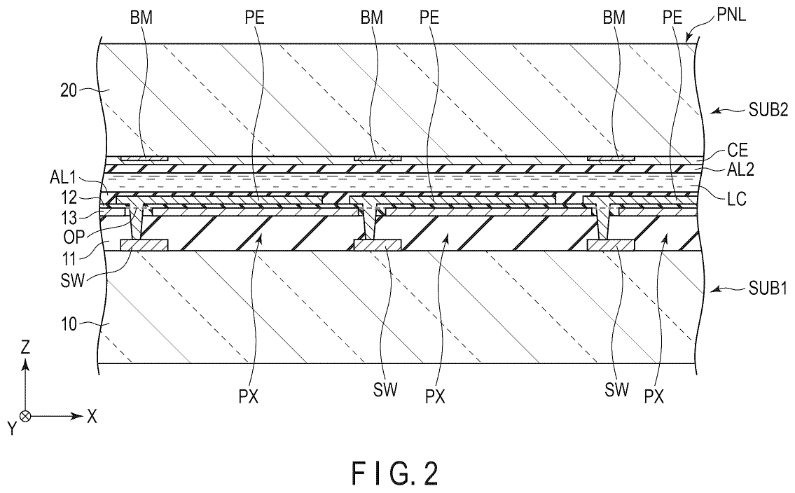

FIG. 2 is a cross-sectional view showing the configuration example of the display panel PNL shown in FIG. 1. The first substrate SUB1 comprises a first transparent substrate 10, insulating films 11 and 12, a capacitive electrode 13, the switching elements SW, the pixel electrodes PE, and an alignment film AL1. Though not shown, the first substrate SUB1 further comprises the scanning lines G and the signal lines S shown in FIG. 1. The switching elements SW are arranged on the upper surface of the first transparent substrate 10. The insulating film 11 covers the switching elements SW. The capacitive electrode 13 may be located between the insulating films 11 and 12. In the shown example, the insulating film 11 and the capacitive electrode 13 are provided over the entire surface of each pixel PX. The configuration is not limited to this example. The insulating film 11 is provided to cover at least the switching element SW, the scanning lines G, and the signal lines S. The capacitive electrode 13 is formed in a grating shape along the scanning lines G and the signal lines S. The pixel electrodes PE are arranged for the respective pixels PX on the insulating film 12. The pixel electrodes PE are electrically connected to the switching elements SW through opening portions OP of the capacitive electrode 13. The pixel electrodes PE overlap the capacitive electrode 13 to form the capacitors CS of the pixels PX with the insulating film 12 interposed between the pixel electrode PE and the capacitive electrode 13. The alignment film AL1 covers the pixel electrodes PE.

The second substrate SUB2 comprises a second transparent substrate 20, a light-shielding layer BM, the common electrode CE, and an alignment film AL2. The second transparent substrate 20 faces the first transparent substrate 10 in the third direction Z. The light-shielding layer BM and the common electrode CE are provided on the lower surface of the second transparent substrate 20. For example, the light-shielding layers BM are located directly above the switching elements SW and directly above the scanning lines G and the signal lines S (not shown), respectively. The common electrode CE faces the pixel electrode PE with the liquid crystal layer LC interposed therebetween in the third direction Z. The common electrode CE is provided over the plurality of pixels PX and directly covers the light-shielding layer BM. The common electrode CE is electrically connected to the capacitive electrode 13 and has the same electric potential as the capacitive electrode 13. The alignment film AL2 covers the common electrode CE.

The liquid crystal layer LC is located between the first transparent substrate 10 and the second transparent substrate 20 and is in contact with the alignment films AL1 and AL2. In the first substrate SUB1, the insulating films 11 and 12, the capacitive electrode 13, the switching elements SW, the pixel electrodes PE, the alignment film AL1, and the scanning lines G and the signal lines S shown in FIG. 1 are located between the first transparent substrate 10 and the liquid crystal layer LC. In the second substrate SUB2, the light-shielding layers BM, the common electrode CE, and the alignment film AL2 are located between the second transparent substrate 20 and the liquid crystal layer LC.

The first transparent substrate 10 and the second transparent substrate 20 are insulating substrates such as glass substrates and plastic substrates. The insulating film 11 is formed of a transparent resin material such as silicon oxide, silicon nitride, silicon oxynitride or acrylic resin. For example, the insulating film 11 includes an inorganic insulating film and an organic insulating film. The insulating film 12 is an inorganic insulating film of silicon nitride or the like. The capacitive electrode 13, the pixel electrodes PE, and the common electrode CE are, for example, transparent electrodes formed of a transparent conductive material such as indium tin oxide (ITO) or indium zinc oxide (IZO). The light-shielding layers BM are, for example, conductive layers having a resistance lower than that of the common electrode CE. For example, the light-shielding layers BM are formed of a nontransparent metal material such as molybdenum, aluminum, tungsten, titanium, or silver. The alignment films AL1 and AL2 are horizontal alignment films having an alignment restriction force substantially parallel to the X-Y plane. For example, the alignment films AL1 and AL2 are subjected to alignment treatment along the first direction X. Incidentally, the alignment treatment may be a rubbing treatment or an optical alignment treatment.

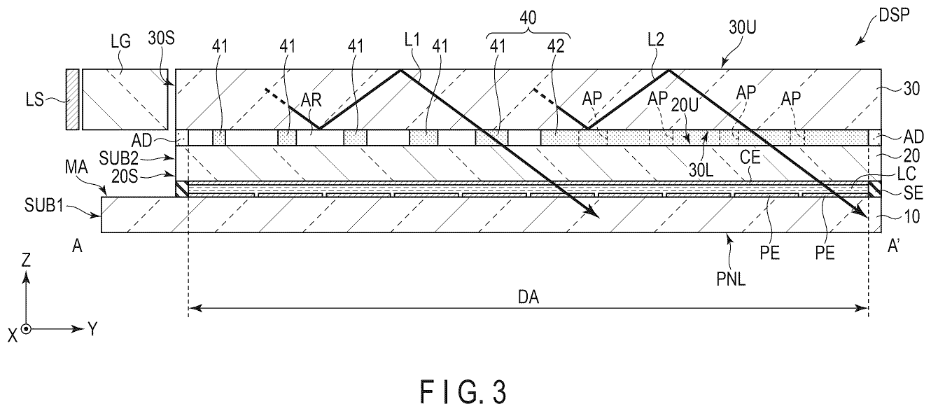

FIG. 3 is a schematic cross-sectional view showing the display device DSP along line A-A′ shown in FIG. 1. FIG. 3 schematically shows the configuration of the display panel PNL and the like and omits the illustration of elements such as the scanning lines G, the signal lines S, and the switching elements SW.

The display panel PNL further comprises a seal SE bonding the first substrate SUB1 and the second substrate SUB2 together. The sealing SE surrounds the display area DA in plan view. The liquid crystal layer LC is enclosed in a space surrounded by the sealing SE.

The display device DSP further comprises a third transparent substrate 30, a structure 40, and an adhesive AD.

The third transparent substrate 30 faces the second transparent substrate 20 in the third direction Z. The third transparent substrate 30 has a side surface 30S facing the plurality of light emitting elements LS in the second direction Y with the light guide LG interposed therebetween. In the example of FIG. 3, the side surface 30S is parallel to the X-Z plane. The side surface 30S overlaps a side surface 20S of the second substrate SUB2 in the third direction Z. The second transparent substrate 20 is located between the first transparent substrate 10 and the third transparent substrate 30.

The third transparent substrate 30 is a cover glasses formed of glass, for example. As another example, the third transparent substrate 30 may be formed of plastic. The third transparent substrate 30 is sufficiently thicker than the first substrate SUB1 and the second substrate SUB2. As an example, the third transparent substrate 30 is twice as thick as each of the first substrate SUB1 and the second substrate SUB2 or more.

The structure 40 is located between the second transparent substrate 20 and the third transparent substrate 30 in the third direction Z and is in contact with the second transparent substrate 20 and the third transparent substrate 30. In the example of FIG. 3, the structure 40 bonds an upper surface 20U of the second transparent substrate 20 and a lower surface 30L of the third transparent substrate 30 together. When the structure 40 has almost no adhesive strength, the structure 40 may be bonded to the second transparent substrate 20 and the third transparent substrate 30 by a transparent adhesive having the refractive index almost equivalent to those of the second transparent substrate 20 and the third transparent substrate 30.

The structure 40 comprises a plurality of first structures 41 and a second structure 42. The plurality of first structures 41 are located to be closer to the light emitting elements LS than the second structure 42 is in the second direction Y. That is, the second structure 42 is farther from the light emitting elements LS than the plurality of first structures 41 are.

The plurality of first structures 41 are formed in a dotted pattern in which the plurality of first structures 41 are arranged at certain pitches in plan view. This arrangement will be described in detail. The plurality of first structures 41 are arranged so as not to overlap each other in plan view. Each of the first structures 41 is surrounded by a low-refractive layer AR having a refractive index smaller than that of the first structure 41. The low-refractive layer AR is not a layer formed of a low-refractive material such as siloxane-based resin and fluorine compounds. The low-refractive layer AR may be, for example, a cavity which is an air layer but is in the evacuated state. In this manner, the low-refractive layer AR in the present specification refers to not a solid layer formed of a low-refractive material but a gas layer such as air and inactive gas or a cavity.

The second structure 42 has a plurality of apertures AP. The plurality of apertures AP are formed in a dotted pattern in which the plurality of apertures AP are arranged at certain pitches in plan view. This arrangement will be described in detail. The plurality of apertures AP are arranged so as not to overlap each other in plan view. Each of the plurality of apertures AP is filed with a medium (gas) having a refractive index lower than that of the second structure 42. For example, each of the plurality of apertures AP is filled with air but may be a cavity in the evacuated state.

As an example, the structure 40 is formed of, for example, a material having an adhesion property such as acrylic resin and epoxy resin. Preferably, the refractive index of the structure 40 is equivalent to the refractive index of each of the second transparent substrate 20 and the third transparent substrate 30.

The adhesive AD bonds the upper surface 20U of the second transparent substrate 20 and the lower surface 30L of the third transparent substrate 30 together. The adhesive AD overlaps the seal SE in the third direction Z. For example, optical clear adhesive (OCA) and the like can be used as the adhesive AD. When the structure 40 has adhesive strength, the adhesive AD may be formed of the same material as that of the structure 40. The refractive index of the adhesive layer AD may be equivalent to or different from the refractive index of each of the structure 40, the second transparent substrate 20, and the third transparent substrate 30.

In the present embodiment, the refractive index of the structure 40 is equivalent to the refractive index of each of the second transparent substrate 20 and the third transparent substrate 30. In addition, the refractive index of air is smaller than the refractive index of each of the third transparent substrate 30 and the structure 40. In this configuration, the light emitted from the light emitting elements LS passes through the light guide LG and is made incident on the third transparent substrate 30 from the side surface 30S. The light made incident on the third transparent substrate 30 is subjected to the total reflection at the boundary between the upper surface 30U of the third transparent substrate 30 and air, the boundary between the lower surface 30L of the third transparent substrate 30 and the low-refractive layer AR, and the boundary between the lower surface 30L of the third transparent substrate 30 and the aperture AP and propagates through the third transparent substrate 30. The refractive index of the structure 40 is equivalent to the refractive index of each of the second transparent substrate 20 and the third transparent substrate 30. Thus, the light propagating through the third transparent substrate 30 is not substantially reflected at the boundary between the lower surface 30L and the structure 40. That is, a part of light propagating through the third transparent substrate 30 passes through the structure 40, the second transparent substrate 20, and the common electrode CE and is made incident on the liquid crystal layer LC. In this manner, the structure 40 has the function of guiding the light emitted from the plurality of light emitting elements LS from the third transparent substrate 30 to the liquid crystal layer LC. Preferably, both refractive index difference between the refractive index of the structure 40 and that of the second transparent substrate 20 and refractive index difference between the refractive index of the structure 40 and that of the third transparent substrate 30 are less than or equal to 0.05 for light not to be reflected at the boundary between the lower surface 30L and the structure 40 and the boundary between the upper surface 20U and the structure 40. In addition, as described above, the light emitting elements LS face the side surface 30S of the third transparent substrate 30 alone in the second direction Y. The light emitted from the light emitting elements LS hardly is directly made incident on the adhesive AD and the display panel PNL.

In the example shown in FIG. 3, light L1 propagating through the third transparent substrate 30 is reflected at the boundary between the lower surface 30L and the low-refractive layer AR. Thereafter, the light L1 is reflected at the boundary between the upper surface 30U and air, passes through the first structure 41, and then is made incident on the display panel PNL. Light L2 propagating through the third transparent substrate 30 is reflected at the boundary between the lower surface 30L and the aperture AP. Thereafter, the light L2 is reflected at the boundary between the upper surface 30U and air, passes through the second structure 42, and then is made incident on the display panel PNL.

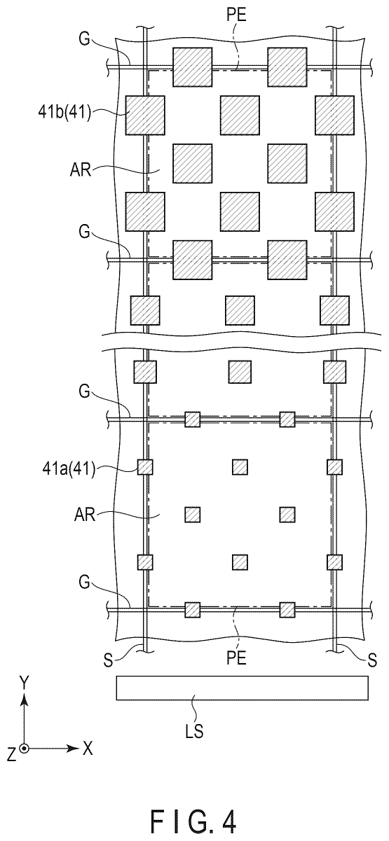

FIG. 4 is a plan view showing an example of the first structures 41. The first structure 41 includes a first structure 41a and a first structure 41b, the first structure 41b being farther from the light emitting elements LS in the second direction Y than the first structure 41a is.

Each of the plurality of pixel electrodes PE is surrounded by two adjacent scanning lines G in the second direction Y and two adjacent signal lines S in the first direction X.

The plurality of first structures 41 overlap the pixel electrode PE in the third direction Z. In the example of FIG. 4, some of the plurality of first structures 41 overlap the plurality of scanning lines G and the plurality of signal lines S in the third direction Z. In the example of FIG. 4, the first structures 41 are arranged at regular intervals in the first direction X and the second direction Y.

In plan view, the sum of the areas of the first structures 41b overlapping one pixel electrode PE (hereinafter referred to as a total area) is greater than the total area of the first structures 41a overlapping one pixel electrode PE. That is, among the total areas of the first structures 41 overlapping one of the pixel electrodes PE in plan view, the farther one pixel electrode PE from the light emitting elements LS in the second direction Y, the larger the total area of the first structure 41 in one pixel electrode PE.

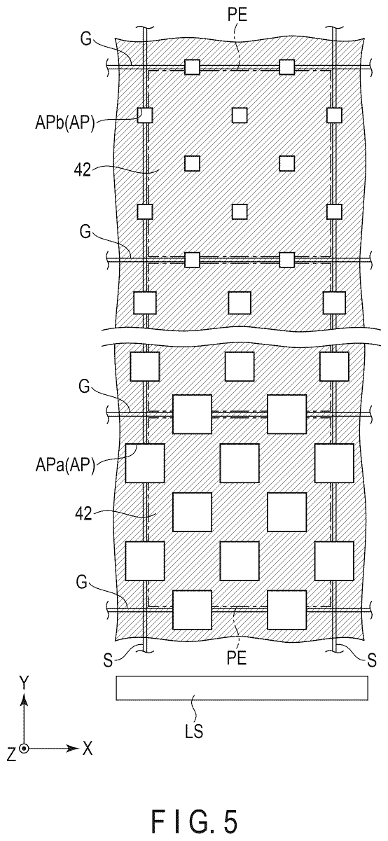

FIG. 5 is a plan view showing an example of the second structures 42 and the apertures AP. The aperture AP includes an aperture APa and an aperture APb, the aperture APb being farther from the light emitting elements LS in the second direction Y than the aperture APa is.

The plurality of apertures AP overlap the pixel electrode PE in the third direction Z. In the example of FIG. 5, some of the plurality of apertures AP overlap the plurality of scanning lines G and the plurality of signal lines S in the third direction Z. In the example shown in FIG. 5, the plurality of apertures AP are arranged at regular intervals in the first direction X and the second direction Y.

In plan view, the total area of the apertures APb overlapping one pixel electrode PE is smaller than the total area of the apertures APa overlapping one pixel electrode PE. That is, among the total areas of the apertures AP overlapping one of the pixel electrodes PE in plan view, the farther one pixel electrode PE from the light emitting elements LS in the second direction Y, the smaller the total area of the apertures AP in one pixel electrode PE. That is, among the total areas of the second structures 42 overlapping one of the pixel electrodes PE, the farther one pixel electrode PE from the light emitting elements LS in the second direction Y, the larger the total area of the second structures 42 in one pixel electrode PE.

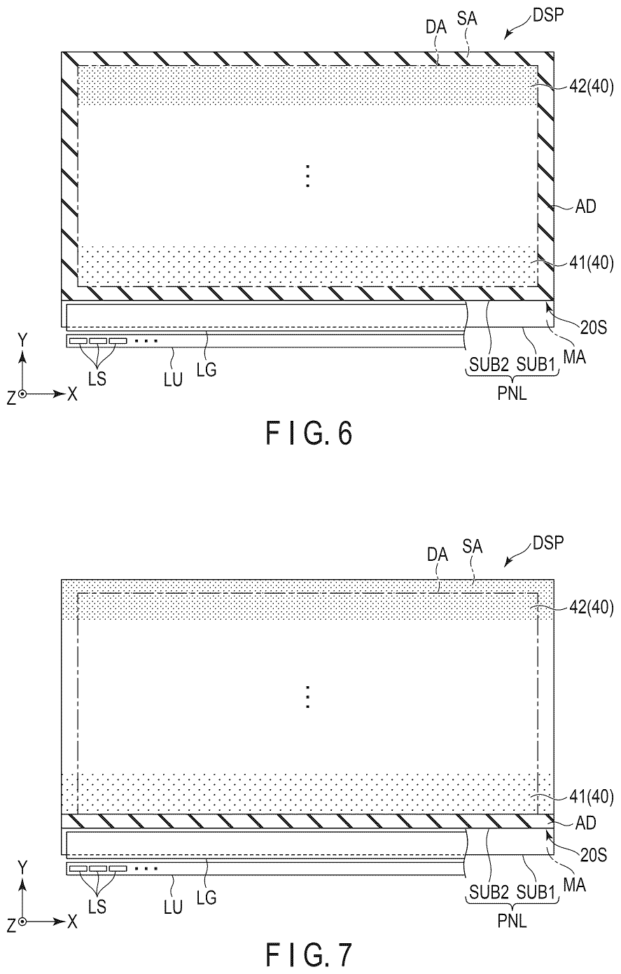

FIG. 6 is a plan view showing a configuration example of the structures 40 and the adhesive AD. The illustration of the third transparent substrate 30 is omitted. In the example of FIG. 6, the adhesive AD is provided in the surrounding area SA and surrounds the display area DA. The adhesive AD surrounds the structure 40 (the first structure 41 and the second structure 42).

The structure 40 is provided in an area surrounded by the adhesive AD. In the example of FIG. 6, the structure 40 overlaps the display area DA. The structure 40 may overlap the display area DA and the surrounding area SA.

FIG. 7 is a plan view showing another configuration example of the structures 40 and the adhesive AD.

The adhesive AD extends along the first direction X and is located between the plurality of light emitting elements LS and the structure 40. More specifically, the adhesive AD is located between the side surface 20S of the second substrate SUB2 and the first structure 41 in plan view. In the example of FIG. 7, the structure 40 overlaps the display area DA and the surrounding area SA. The structure 40 may overlap the display area DA alone.

As shown in FIG. 4 and FIG. 5, among the plurality of structures 40, the closer one structure 40 to the light emitting elements LS, the smaller its area. That is, when the structure 40 has adhesive strength, among adhered areas, the closer one adhered area of the second transparent substrate 20 and the third transparent substrate 30 to the light emitting elements LS, the smaller its area. Thus, compared to a position farther from the light emitting elements LS, the third transparent substrate 30 is more easily detached from the display panel PNL in a position closer to the light emitting elements LS. In contrast, in the present embodiment, the adhesive AD is provided between the light emitting elements LS and the structure 40. This configuration suppresses the detachment of the third transparent substrate 30 from the display panel PNL in a side closer to the light emitting elements LS. As shown in FIG. 6, the adhesive AD is provided to surround the structure 40. This configuration further suppresses the detachment of the third transparent substrate 30 from the display panel PNL.

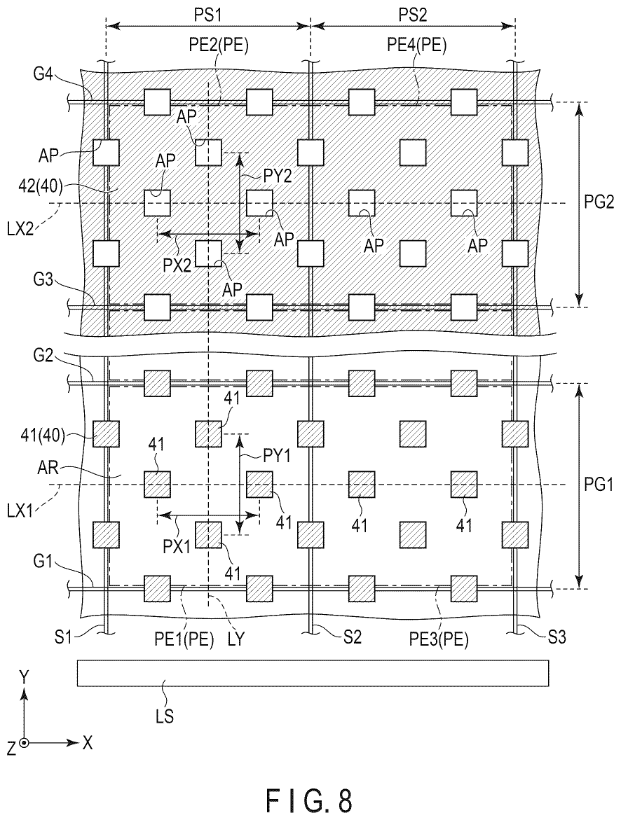

FIG. 8 is a plan view showing an example of a relationship among the structures 40 and the pixel electrodes PE.

The pixel electrode PE includes pixel electrodes PE1 to PE4. In the example shown in FIG. 8, the pixel electrodes PE1 and PE2 are provided along the second direction Y. The pixel electrodes PE3 and PE4 are provided along the second direction Y. The pixel electrodes PE1 and PE3 are provided along the first direction X. The pixel electrodes PE2 and PE4 are provided along the first direction X. The pixel electrodes PE2 and PE4 (second pixel electrodes) are farther from the light emitting elements LS than the pixel electrodes PE1 and PE3 (first pixel electrodes) are. That is, the pixel electrodes PE1 and PE3 are located between the light emitting elements LS and the pixel electrodes PE2 and PE4 in plan view. The pixel electrodes PE1 and PE3 are provided in pixels in an area extremely close to the light emitting elements LS. The pixel electrodes PE2 and PE4 are provided in pixels in an area extremely farther from the light emitting elements LS. A large number of pixel electrodes are arranged between the pixel electrode PE1 and the pixel electrode PE2 and between the pixel electrode PE3 and the pixel electrode PE4.

The plurality of scanning lines G shown in FIG. 1 include scanning lines G1 to G4. The plurality of signal lines S shown in FIG. 1 include signal lines S1 to S3. The scanning line G1 is adjacent to the scanning line G2. The scanning lines G1 and G2 are arranged at a pitch PG1 (a fourth pitch) in the second direction Y. The scanning line G3 is adjacent to the scanning line G4. The scanning lines G3 and G4 are arranged at a pitch PG2 (a fourth pitch) in the second direction Y. The signal line S1 is adjacent to the signal line S2. The signal lines S1 and S2 are arranged at a pitch PS1 (a third pitch) in the first direction X. The signal line S2 is adjacent to the signal line S3. The signal lines S2 and S3 are arranged at a pitch PS2 (a third pitch) in the first direction X. The pixel electrode PE1 is surrounded by the scanning lines G1 and G2 and the signal lines S1 and S2. The pixel electrode PE2 is surrounded by the scanning lines G3 and G4 and the signal lines S1 and S2. The pixel electrode PE3 is surrounded by the scanning lines G1 and G2 and the signal lines S2 and S3. The pixel electrode PE4 is surrounded by the scanning lines G3 and G4 and the signal lines S2 and S3. The pixel electrodes PE1 and PE2 are electrically connected to, for example, the signal line S1. The pixel electrodes PE3 and PE4 are electrically connected to, for example, the signal line S2.

The plurality of first structures 41 overlaps the pixel electrodes PE1 and PE3. In the example of FIG. 8, the plurality of first structures 41 overlap the second scanning lines G1 and G2 and the signal lines S1, S2, and S3. That is, a pair of the scanning lines G1 and G2 located on respective end sides of the pixel electrode PE1, among the plurality of scanning lines G, and a pair of the signal lines S1 and S2 located on respective end sides of the pixel electrode PE1, among the plurality of signal lines S, overlap the plurality of first structures 41. Similarly, a pair of the scanning lines G1 and G2 located on respective end sides of the pixel electrode PE3, among the plurality of scanning lines G, and a pair of the signal lines S2 and S3 located on respective end sides of the pixel electrode PE1, among the plurality of signal lines S, overlap the plurality of first structures 41.

In the shown examples, the first structures 41 overlapping the pixel electrode PE1 have the same shape. The areas of these first structures 41 are substantially equivalent to one another. In the example of FIG. 8, the plurality of first structures 41 have the square shape. The configuration is not limited to this example. For example, the plurality of first structures 41 may have the rectangular shape or the circular shape. In addition, in the example of FIG. 8, the area of each of the plurality of first structures 41 is smaller than the area of each of the pixel electrodes PE1 and PE3. The number of the first structures 41 overlapping the pixel electrodes PE1 and PE3 is not limited to the shown example.

In the present embodiment, the plurality of first structures 41 are regularly provided. In the example of FIG. 8, the plurality of first structures 41 are arranged in a staggered manner. More specifically, the first structures 41 arranged on a line parallel to the first direction X and the first structures 41 arranged on a line that is shifted from the line by a row in the second direction Y are ½ pitch apart from each other in the first direction X.

As shown in FIG. 8, the plurality of first structures 41 are arranged at a pitch PX1 (a first pitch) in the first direction X. The plurality of first structures 41 are arranged at a pitch PY1 (a second pitch) in the second direction Y. In the example of FIG. 8, the pitch PY1 is equivalent to the pitch PX1. Here, the pitch PX1 is a distance along the first direction X between the centers of respective two adjacent first structures 41 on a line LX1 parallel to the first direction X (the extending direction of the scanning lines G1 to G4). Here, the pitch PY1 is a distance along the second direction Y between the centers of respective two adjacent first structures 41 on a line LY parallel to the second direction Y (the extending direction of the signal lines S1 to S3). As far as the first structures 41 are arranged such that the pitch PX1 and the pitch PY1 are equivalent to each other, the arrangement pattern may be other than the staggered arrangement.

The second structure 42 includes the plurality of apertures AP as described above. The plurality of apertures AP overlap the pixel electrode PE2. In the example of FIG. 8, the plurality of apertures AP overlap the scanning lines G3 and G4 and the signal lines S1, S2, and S3. That is, a pair of the scanning lines G3 and G4 located on respective end sides of the pixel electrode PE2, among the plurality of scanning lines G, and a pair of the signal lines S1 and S2 located on respective end sides of the pixel electrode PE2, among the plurality of signal lines S, overlap the plurality of apertures AP. Similarly, a pair of the scanning lines G3 and G4 located on respective end sides of the pixel electrode PE4, among the plurality of scanning lines G, and a pair of the signal lines S2 and S3 located on respective end sides of the pixel electrode PE4, among the plurality of signal lines S, overlap the plurality of apertures AP.

In the shown examples, the apertures AP overlapping the pixel electrode PE2 have the same shape. The areas of these apertures AP are substantially equivalent to one another. In the example of FIG. 8, the plurality of apertures AP have the square shape. The configuration is not limited to this example. For example, the plurality of apertures AP may have the rectangular shape and the circular shape. In addition, in the example of FIG. 8, the area of each of the plurality of apertures AP is smaller than the area of each of the pixel electrodes PE2 and PE4. The number of the apertures AP overlapping the pixel electrodes PE2 and PE4 is not limited to the shown example.

In the present embodiment, the plurality of apertures AP are regularly provided. In the example of FIG. 8, the plurality of apertures AP are arranged in a staggered manner. More specifically, the apertures AP arranged on a line parallel to the first direction X and the apertures AP arranged on a line that is shifted from the line by a row in the second direction Y are ½ pitch apart from each other in the first direction X.

As shown in FIG. 8, the plurality of apertures AP are arranged at a pitch PX2 (the first pitch) in the first direction X. The plurality of apertures AP are arranged at a pitch PY2 (the second pitch) in the second direction Y. In the example of FIG. 8, the pitch PY2 is equivalent to the pitch PX2. Here, the pitch PX2 is a distance along the first direction X between the centers of respective two apertures AP on a line LX2 parallel to the first direction X (the extending direction of the scanning lines G1 to G4). Here, the pitch PY2 is a distance along the second direction Y between the centers of respective two apertures AP on the line LY parallel to the second direction Y (the extending direction of the signal lines S1 to S3). As far as the apertures AP are arranged such that the pitch PX2 and the pitch PY2 are equivalent to each other, the arrangement pattern may be other than the staggered arrangement.

The pitch PS1 is preferably an integral multiple of the pitches PX1 and PX2. In the example of FIG. 8, the pitch PS1 is the twice the length of each of the pitches PX1 and PX2. In the same manner preferably, the pitch PS2 is an integral multiple of the pitches PX1 and PX2, the pitch PG1 is an integral multiple of the pitch PY1, and the pitch PG2 is an integral multiple of the pitch PY2. In the example of FIG. 8, the pitch PS2 is twice the length of the pitches PX1 and PX2, the pitch PG1 is twice the length of the pitch PY1, and the pitch PG2 is twice the length of the pitch PY2.

In this configuration, the total area of the first structures 41 overlapping one pixel electrode PE in plan view is the same in each of the pixel electrodes PE arranged along the first direction X. In the example of FIG. 8, the total area of the first structures 41 overlapping the pixel electrode PE1 is equivalent to the total area of the first structures 41 overlapping the pixel electrode PE3. In the same manner, the total area of the apertures AP overlapping one pixel electrode PE in plan view is the same in each of the pixel electrodes PE arranged along the first direction X. In the example of FIG. 8, the total area of the apertures AP overlapping the pixel electrode PE2 is equivalent to the total area of the apertures AP overlapping the pixel electrode PE4.

Thus, amounts of the light made incident on the pixel electrodes PE are substantially equivalent to one another in the pixel electrodes PE arranged in the first direction X. This configuration can suppress the occurrence of moire due to differences in light amounts among pixels and thus suppress the degradation in display quality.

In this configuration, the pattern of the first structures 41 overlapping each of the pixel electrodes PE is the same in each of the pixel electrodes PE in the first direction X. In the example of FIG. 8, the pattern of the first structures 41 overlapping the pixel electrode PE1 is the same as the first structures 41 overlapping the pixel electrode PE3. The pattern of the first structures 41 overlapping each of the pixel electrodes PE is the same in each of the pixel electrodes PE arranged in the first direction X and including the pixel electrodes PE1 and PE3.

Similarly, the pattern of the apertures AP overlapping each of the pixel electrodes PE is the same in each of the pixel electrodes PE in the first direction X. In the example of FIG. 8, the pattern of the apertures AP overlapping the pixel electrode PE2 is the same as that of the apertures AP overlapping the pixel electrode PE4. The pattern of the apertures AP overlapping each of the pixel electrodes PE is the same in each of the pixel electrodes PE arranged in the first direction X and including the pixel electrodes PE2 and PE4.

When the pitches of the scanning lines and the signal lines are not integrals multiple of the pitch of the first structure 41 and the aperture AP, the patterns of the first structures 41 and the apertures AP overlapping each of the pixel electrodes PE are different in respective pixel electrodes PE in the first direction X. In this configuration, a portion in which the first structure 41 and the aperture AP are in close contact and a portion in which the first structure 41 and the aperture AP are spaced apart from each other are formed in the first direction X. Thus, a stripe pattern is formed. This may cause the degradation in display quality.

In contrast, in the present embodiment, the pattern of the first structures 41 and the apertures AP that overlap each of the pixel electrodes PE is the same in each of the pixel electrodes PE arranged in the first direction X. This configuration can suppress the formation of the stripe pattern and thus suppress the degradation in display quality.

In the present embodiment, the area in which the first structure 41 and the pixel electrode PE1 overlap each other is smaller than the area in which the second structure 42 and the pixel electrode PE2 overlap each other. Among the plurality of first structures 41, the farther one first structure 41 from the light emitting elements LS, the larger its area in plan view. Among the plurality of apertures AP, the farther one aperture AP from the light emitting elements LS, the smaller its area in plan view. Thus, an area in which the light emitted from the light emitting elements LS can be made incident on the pixel electrode PE1 is smaller than an area in which the light emitted from the light emitting elements LS can be made incident on the pixel electrode PE2. In contrast, the light emitted from the light emitting elements LS attenuate as this light becomes farther from the light emitting elements LS. Therefore, the brightness of light in the area closer to the light emitting elements LS is higher than the brightness of light in the area farther from the light emitting elements LS. That is, the brightness of the light made incident on the pixel electrode PE1 is higher than the brightness of the light made incident on the pixel electrode PE2. Thus, the amounts of light in the pixel electrode PE1 and the pixel electrode PE2 can be substantially equivalent to each other. This can suppress the degradation in display quality.

In addition, as described above, the light emitting elements LS face the side surface 30S of the third transparent substrate 30 alone in the second direction Y. The light emitted from the light emitting elements LS hardly is directly made incident on the adhesive AD and the display panel PNL. Therefore, the degradation in display quality due to undesirable scattering at the adhesive AD and the seal SE can be suppressed. Further, the luminance gradient resulted from light emitted from the light emitting elements LS being directly made incident on the first substrate SUB1 and the second substrate SUB2 can be reduced.

Commonly, siloxane-based resin and fluorine compounds can be used in the low-refractive layers reflecting light emitted from the light emitting elements. However, siloxane-based resin easily gasifies and may cause various adverse effect during the production process. In addition, the trend toward regulating fluorine compounds is globally on the rise. In contrast, in the present embodiment, the low-refractive layer AR is air layer and the aperture AP is filled with air. Further, the structure 40 is formed of the material such as the acrylic resin and the epoxy resin. Therefore, the present embodiment can provide a display device capable of suppressing the degradation in display quality without a low refractive index material such as siloxane-based resin and fluorine compounds.

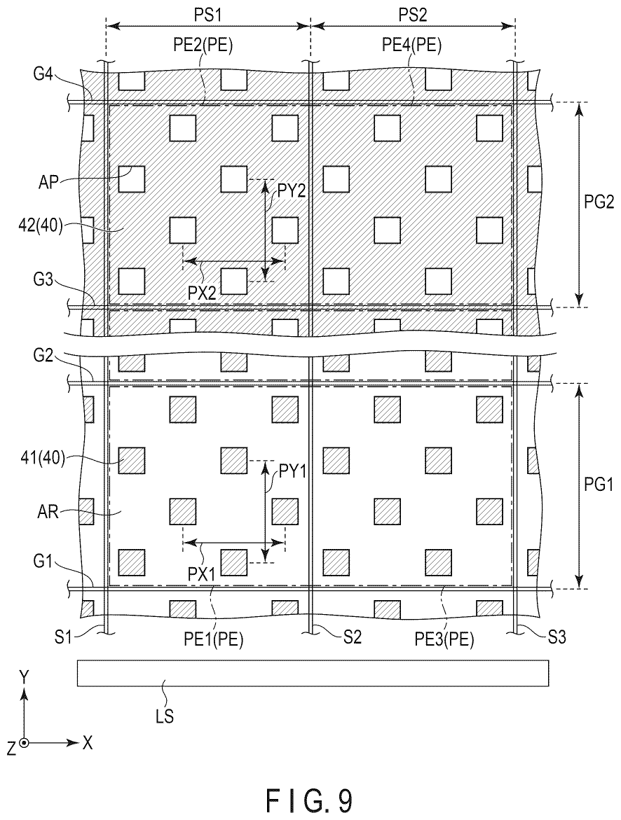

FIG. 9 is a plan view showing another configuration example of the relationship among the structures 40 and the pixel electrodes PE. The configuration shown in FIG. 9 is different from the configuration shown in FIG. 8 in the point that the first structure 41 and the aperture AP do not overlap the scanning lines G1 to G4 and the signal lines S1 to S3.

In FIG. 9 as well, similarly to FIG. 8, the pitch PS1 is an integral multiple (twice) of the pitches PX1 and PX2, the pitch PS2 is an integral multiple (twice) of the pitches PX1 and PX2, the pitch PG1 is an integral multiple (twice) of the pitch PY1, and the pitch PG2 is an integral multiple (twice) of the pitch PY2. Therefore, as shown in FIG. 9, even when the first structures 41 and the apertures AP do not overlap the scanning lines G1 to G4 and the signal lines S1 to S3, the same effect as those described with reference to FIG. 8 can be obtained.

Here, an example of a method of forming the structure 40 is a method of forming the structure 40 by applying a material for forming the structure 40 onto the second transparent substrate 20 or the third transparent substrate 30, and then drying and patterning it. This manufacturing process requires accurate positioning in patterning and accurate bonding of the substrates. In contrast, the present embodiment has the pitch of the scanning lines and the signal lines that is an integral multiple of the pitch of the first structure 41 and the aperture AP as shown in FIG. 8 and FIG. 9, and thus can achieve the above effects by even when the position of the first structure 41 and the aperture AP is shifted more than a set value in patterning or the bonding of the substrates.

### Second Embodiment

Next, the second embodiment will be described. The same elements as those of the first embodiment are denoted by the same reference numbers and overlapping descriptions of these elements are omitted.

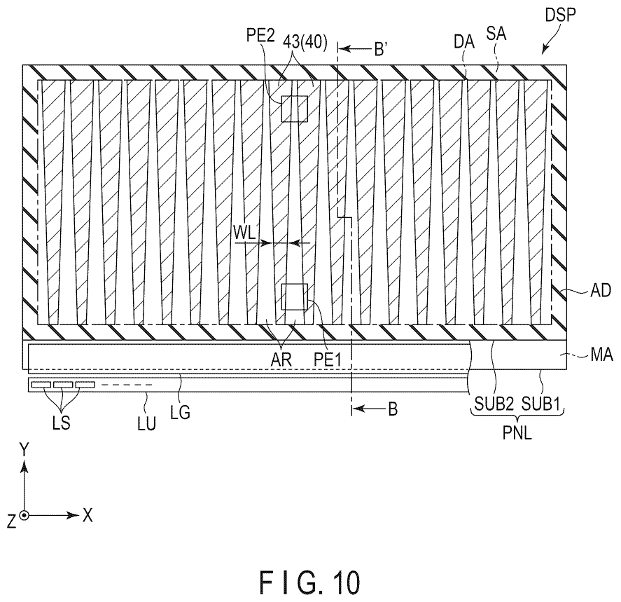

FIG. 10 is a view showing a schematic configuration example of a display device DSP of the second embodiment. The present embodiment is different from the first embodiment in the shape of the structure 40.

The structure 40 comprises a plurality of strip portions 43 arranged at intervals in the first direction X. Each of the strip portions 43 extends along the second direction Y. A low-refractive layer AR is provided between adjacent strip portions 43. The plurality of strip portions 43 are provided in a display area DA. The plurality of strip portions 43 may be arranged in the display area DA and a surrounding area SA.

In the example of FIG. 10, the strip portion 43 has a trapezoidal shape in which a width WL (a length along the first direction X) increases as the strip portion 43 becomes farther from the plurality of light emitting elements LS. As an example, the pixel electrode PE overlaps two adjacent strip portions 43 in plan view. Therefore, the area in which the strip portion 43 overlaps the pixel electrode PE1 is smaller than the area in which the strip portion 43 overlaps the pixel electrode PE2.

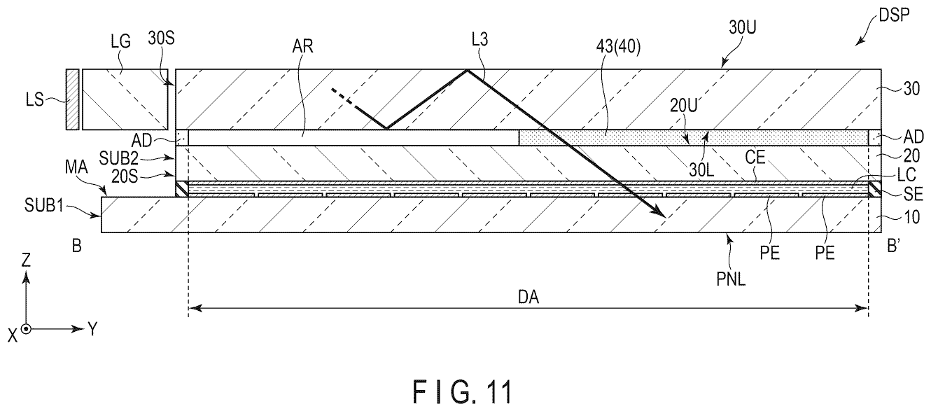

FIG. 11 is a schematic cross-sectional view showing the display device DSP along line B-B′ shown in FIG. 10.

In the example shown in FIG. 11, light L3 propagating through a third transparent substrate 30 is reflected at the boundary between a lower surface 30L of the third transparent substrate 30 and the low-refractive layer AR. Thereafter, the light L3 is reflected at the boundary between an upper surface 30U of the third transparent substrate 30 and air, passes through a first structure 41, and then is made incident on a display panel PNL.

Thus, similarly to the first embodiment, in the second embodiment as well, an area in which the light emitted from the light emitting elements LS can be made incident on the pixel electrode PE1 is smaller than an area in which the light emitted from light emitting elements LS can be made incident on the pixel electrode PE2. Therefore, the amounts of illumination light in the pixel electrode PE1 and the pixel electrode PE2 can be substantially equivalent to each other.

All of the display devices that can be implemented by a person of ordinary skill in the art through arbitrary design changes to the display device described above as the embodiment of the present invention come within the scope of the present invention as long as they are in keeping with the spirit of the present invention.

Various types of the modified examples are easily conceivable within the category of the ideas of the present invention by a person of ordinary skill in the art and the modified examples are also considered to fall within the scope of the present invention. For example, additions, deletions or changes in design of the constituent elements or additions, omissions, or changes in condition of the processes arbitrarily conducted by a person of ordinary skill in the art, in the above embodiments, fall within the scope of the present invention as long as they are in keeping with the spirit of the present invention.

In addition, the other advantages of the aspects described in the embodiments, which are obvious from the descriptions of the present specification or which can be arbitrarily conceived by a person of ordinary skill in the art, are considered to be achievable by the present invention as a matter of course.

What is claimed is:

1. A display device, comprising:
a display panel comprising:
a first transparent substrate;
a second transparent substrate facing the first transparent substrate;
a liquid crystal layer located between the first transparent substrate and the second transparent substrate and containing polymer dispersed liquid crystal;
a first pixel electrode and a second pixel electrode that are located between the first transparent substrate and the liquid crystal layer; and
a common electrode located between the second transparent substrate and the liquid crystal layer and facing the first pixel electrode and the second pixel electrode;
a plurality of light emitting elements arranged in a first direction;
a third transparent substrate having a side surface facing the plurality of light emitting elements; and
a plurality of structures in contact with the second transparent substrate and the third transparent substrate and guide light from the third transparent substrate to the liquid crystal layer, the light being emitted from the plurality of light emitting elements, wherein
the second transparent substrate is located between the first transparent substrate and the third transparent substrate,
the first pixel electrode is located between the plurality of light emitting elements and the second pixel electrode in plan view,
the plurality of structures comprise a plurality of first structures overlapping the first pixel electrode and a second structure having a plurality of apertures overlapping the second pixel electrode,
the plurality of first structures and the plurality of apertures are arranged in a first pitch in the first direction, and are arranged in a second pitch equivalent to the first pitch in a second direction orthogonal to the first direction,
some of the first structures overlap the first pixel electrode, and
a sum of areas of the some of the first structures is smaller than an area in which the second structure overlaps the second pixel electrode.

2. The display device of claim 1, wherein
the display panel further comprises:
a plurality of scanning lines located between the first transparent substrate and the liquid crystal layer; and
a plurality of signal lines intersecting the plurality of scanning lines, wherein
the plurality of signal lines are arranged at a third pitch in the first direction,
the plurality of scanning lines are arranged at a fourth pitch in the second direction,
the third pitch is an integral multiple of the first pitch, and
the fourth pitch is an integral multiple of the second pitch.

3. The display device of claim 2, wherein
a first pair of the plurality of scanning lines located on respective both ends of the first pixel electrode, and a first pair of the signal lines located on the respective both ends of the first pixel electrode overlap the some of the plurality of first structures, the first pair of the plurality of scanning lines being two of nearest to the first pixel electrode among all the scanning lines and the first pair of the plurality of signal lines being two of nearest to the first pixel electrode among all the signal lines, and
a second pair of the scanning lines located on respective both ends of the second pixel electrode, and a second pair of the signal lines located on the respective both ends of the second pixel electrode overlap some of the plurality of apertures, the second pair of the plurality of scanning lines being two of nearest to the second pixel electrode among all the scanning lines and the second pair of the plurality of signal lines being two of nearest to the second pixel electrode among all the signal lines.

4. The display device of claim 1, wherein
a refractive index of each of the plurality of structures is equivalent to a refractive index of each of the second transparent substrate and the third transparent substrate.

5. The display device of claim 1, wherein
each of a refractive index difference between a refractive index of each of the plurality of structures and a refractive index of the second transparent substrate and a refractive index difference between the refractive index of each of the plurality of structures and a refractive index of the third transparent substrate is less than or equal to 0.05.

6. The display device of claim 1, wherein
an area of each of the plurality of first structures is smaller than an area of the first pixel electrode.

7. The display device of claim 1, wherein
an area of each of the plurality of apertures is smaller than an area of the second pixel electrode.

8. The display device of claim 1, wherein
the plurality of first structures are arranged in a staggered manner.

9. The display device of claim 1, wherein
the plurality of apertures are arranged in a staggered manner.

10. The display device of claim 1, wherein
the plurality of structures are formed of an acrylic resin or an epoxy resin.

11. The display device of claim 1, further comprising:
an adhesive bonding the second transparent substrate and the third transparent substrate together, wherein
at least a part of the adhesive is located between the plurality of light emitting elements and the plurality of structures in plan view.

12. The display device of claim 11, wherein
the adhesive is entirely located between the plurality of light emitting elements and the plurality of structures in plan view.

13. The display device of claim 11, wherein
a refractive index of the adhesive is equivalent to a refractive index of each of the plurality of structures.

14. The display device of claim 1, further comprising:
an adhesive bonding the second transparent substrate and the third transparent substrate together, wherein
the adhesive surrounds the plurality of structures.

15. The display device of claim 14, wherein
a refractive index of the adhesive is equivalent to a refractive index of each of the plurality of structures.

16. The display device of claim 1, wherein
one of the plurality of first structures is surround by a cavity located between a main surface of the second transparent substrate and a main surface of the third transparent substrate.

17. The display device of claim 16, wherein
the cavity is in an evacuated state.

18. The display device of claim 16, wherein
the cavity is filled with air or inactive gas.

19. A display device, comprising:
a display panel comprising:
a first transparent substrate;
a second transparent substrate facing the first transparent substrate;
a liquid crystal layer located between the first transparent substrate and the second transparent substrate and containing polymer dispersed liquid crystal;
a first pixel electrode and a second pixel electrode that are located between the first transparent substrate and the liquid crystal layer; and
a common electrode located between the second transparent substrate and the liquid crystal layer and facing the first pixel electrode and the second pixel electrode;
a plurality of light emitting elements arranged in a first direction;
a third transparent substrate having a side surface facing the plurality of light emitting elements; and
a plurality of resin layers located between a main surface of the second transparent substrate and a main surface of the third transparent substrate, wherein
the second transparent substrate is located between the first transparent substrate and the third transparent substrate,
the first pixel electrode is located between the plurality of light emitting elements and the second pixel electrode in plan view,
the plurality of resin layers comprise a plurality of first resin layers overlapping the first pixel electrode and a second resin layer having a plurality of apertures overlapping the second pixel electrode,
some of the plurality of first resin layers overlap the first pixel electrode, and
the second resin layer fully overlaps the second pixel electrode.

20. The display device of claim 19, wherein
the second resin layer has an area that is a main surface different from the aperture, and
a sum of areas of the some of the plurality of first resin layers is smaller than an area in which the area and the second pixel electrode overlap each other.
